(19) United States
(12) Patent Application Publication
(10) Pub. No.: US 2005/0284443 A1
(43) Pub. Date: Dec. 29, 2005

(54) Fuel injection system for an internal combustion engine and method for operating a fuel injection system

(76) Inventors: Andreas Huber, Steinheim (DE); Andreas-Juergen Rohatschek, Wernau-Neckar (DE)

Correspondence Address: KENYON & KENYON, ONE BROADWAY, NEW YORK, NY, 10004, US

(21) Appl. No.: 10/509,726

(22) PCT Filed: Apr. 4, 2003
(86) PCT No.: PCT/DE03/01112

§ 371 Date: Jul. 28, 2005

(30) Foreign Application Priority Data
Apr. 9, 2002 (DE) 102 15 627.1

(51) Int. Cl. F02B 3/00; F02M 51/00

(52) U.S. Cl. 123/299; 123/478

(57) ABSTRACT

A fuel injection system for an internal combustion engine having at least two cylinders is provided, the fuel injection system including at least two actuator elements, with one actuator element being assigned to each cylinder for injecting fuel into the cylinder, and an injection-regulating system for monitoring and/or resolving a conflict during triggering of the actuator elements. The injection-regulating system triggers the actuator elements earlier and/or later, or not at all, as a function of the charging and/or discharging edges of the injection elements during injections.

### FIELD OF THE INVENTION

The present invention relates to a fuel injection system for an internal combustion engine having at least two cylinders, the fuel injection system including at least two actuator elements, and at least one actuator element being assigned to each cylinder for injecting fuel into the cylinder. The present invention also relates to a method for operating a fuel injection system of this type.

### BACKGROUND INFORMATION

Published German patent document DE 100 33 343 discloses a fuel injection system for an internal combustion engine, in particular a diesel engine, that has an injection-regulating system for monitoring and/or resolving conflicts during triggering of the actuator elements, in particular a conflict management system for superimposed injection operations of piezoelectric actuators.

In the case of piezoelectric common-rail actuators, a triggering edge may only be executed simultaneously. For reasons of combustion engineering, however, it is necessary to calibrate the triggering of complementary banks so that injections are superimposed. This is possible using the circuit device for connecting piezoelectric elements described, for example, in published German patent document DE 100 33 343, if the charging or discharging edges of the piezoelectric elements do not overlap. In the case of overlapping edges, the fuel injection system described in published German patent document DE 100 33 343 provides that the triggering having low priority (referred to hereinafter as low-priority triggering) is shifted or shortened.

According to published German patent document DE 100 33 343, however, only one response occurs in the case of low-priority injections, namely a shortening of the low-priority injection so that one actuator is not charged while another is to be charged or discharged, or a shifting of the low-priority injection so that edges of injections by different actuators do not overlap, or a delay in-the low-priority injection so that edges of different injections do not overlap.

An object of the present invention is to provide a fuel injection system for an internal combustion engine and a method for operating a fuel injection system so that any collisions, e.g., collisions of injections of the same priority, may be prevented.

### SUMMARY

The above object is achieved in a fuel injection system for an internal combustion engine according to the present invention in that the injection-regulating system triggers the actuator elements earlier, and/or later, or not at all, as a function of the charging and/or discharging edges of the injection elements during injections.

The object is also achieved by a fuel injection system for an internal combustion engine, e.g., a diesel engine, having at least two cylinders, the fuel injection system including at least two piezoelectric elements with one piezoelectric element being assigned to each cylinder for injecting fuel into the cylinder by charging or discharging the piezoelectric element, and a single supply unit for charging or discharging the piezoelectric element being assigned to the piezoelectric elements. The fuel injection system also includes an injection-regulating system for monitoring a possible overlapping of a time interval in which one piezoelectric element is to be charged or discharged with a time interval in which the other piezoelectric element is to be charged or discharged, and different priorities are assigned to at least two injections so that one injection (high-priority injection) is assigned a higher priority than at least one other injection (low-priority injection). In this manner, the injection-regulating system advances and/or retards and/or cancels the at least one injection having the lower priority and/or the at least one injection having the higher priority as a function of charging and/or discharging edges of the injection elements during injections.

One example embodiment of the present invention provides that the shift occurs as a function of the injection priority.

In another example embodiment of the present invention, however, the shift may also occur independently of priority.

Furthermore, the shift may occur as a function of the type of injection, i.e., as a function of whether it is a pilot injection, a main injection or a post-injection.

In a further example embodiment of the present invention, the shift occurs as a function of preceding shifts.

Furthermore, the shift may occur as a function of or independently of the type of overlapping of at least two injections.

In the case of singular primary collisions, i.e., in the case of an overlapping of any two edges having the same or a different priority when no other edge pair overlaps, the following shifts are possible:

a) advancing the edge having low priority (low-priority edge), or

b) retarding the low-priority edge, or

c) advancing the edge having higher priority (higher-priority edge), or

d) retarding the higher-priority edge, or

e) advancing the higher-priority edge, and simultaneously retarding the low-priority edge, or

f) retarding the higher-priority edge, and simultaneously advancing the low-priority edge, or

g) retarding the higher-priority edge and simultaneously retarding the low-priority edge, or

h) advancing the higher-priority edge, simultaneously advancing the low-priority edge, in which case the time interval in which one piezoelectric element is to be charged or discharged does not overlap with the time interval in which the other piezoelectric element is to be charged or discharged.

Another example embodiment of the present invention provides that the edges not involved in overlapping are advanced or retarded or are even left unshifted. For example, the injection assigned to the high-priority edge or the injection assigned to the low-priority edge may not be executed at all—provided that this is causally possible in each case.

In the case of multiple primary collisions, i.e., in the case of combined overlapping of any three or four edges, where, for example, in the case of the overlapping of four edges, they overlap either in combination or separately, then the following shift occurs:

a) Each of the overlapping edges may be advanced or retarded.

b) Not all overlapping edges must be shifted.

c) In addition, edges that are not involved in overlapping are advanced or retarded.

### BRIEF DESCRIPTION OF THE DRAWINGS

FIG. 1 shows a configuration of piezoelectric elements known from the related art.

FIG. 2a shows the charging of a piezoelectric element.

FIG. 2b shows the charging of a piezoelectric element.

FIG. 2c shows the discharging of a piezoelectric element.

FIG. 2d shows the discharging of a piezoelectric element.

FIG. 3 shows a triggering IC.

FIG. 4 shows the sequence of interrupts over time as known from the related art.

FIG. 5 shows schematically the combination of overlapping edges of two injections.

FIG. 6 shows schematically the assignment of priorities.

FIG. 7 shows measures for shifting in the case of singular primary collisions of edges.

### DETAILED DESCRIPTION

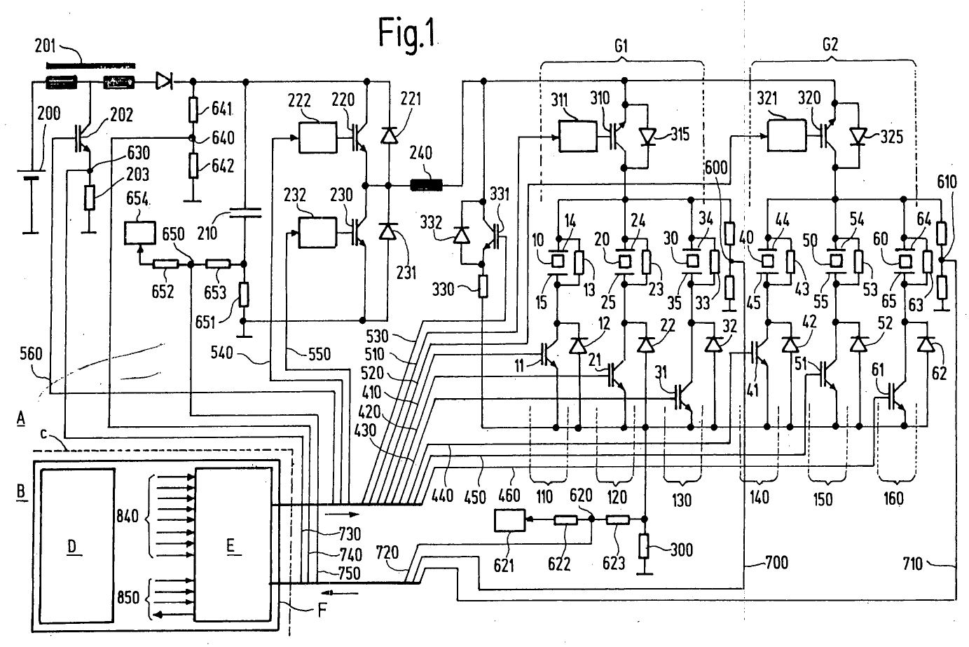

FIG. 1 shows piezoelectric elements 10, 20, 30, 40, 50, 60, and also means for triggering them. A designates an area shown in detail, and B designates an area shown without details, the separation between them being indicated by a broken line c. Area A, which is shown in detail, includes a circuit for charging and discharging piezoelectric elements 10, 20, 30, 40, 50 and 60. In the embodiment shown, piezoelectric elements 10, 20, 30, 40, 50 and 60 are actuators in fuel injectors (in particular in what are referred to as common-rail injectors) of an internal combustion engine. In the embodiment described, six piezoelectric elements 10, 20, 30, 40, 50 and 60 are used for the independent control of six cylinders inside an internal combustion engine; for any other purposes, however, any other number of piezoelectric elements may be suitable.

Area B, the area shown without details, includes an injection-regulating system F having a control unit D and a trigger IC E, which is used to control the elements within area A, the area shown in detail. Different measured values of voltages and currents from the entire remaining triggering circuit of the piezoelectric element are fed to trigger IC E. According to the present invention, control computer D and trigger IC E are designed for regulating the triggering voltages and the triggering times for the piezoelectric element. Control computer D and/or trigger IC E are also designed for monitoring different voltages and currents of the entire triggering circuit of the piezoelectric element.

In the following description, the individual elements within area A, the area shown in detail, will be introduced. That will be followed by a general description of the processes of charging and discharging piezoelectric elements 10, 20, 30, 40, 50 and 60. Finally, the way in which the two processes are controlled and monitored by control computer D and trigger IC E will be described in detail.

Piezoelectric elements 10, 20, 30, 40, 50 and 60 are divided into a first group G1 and a second group G2 that include three piezoelectric elements each (i.e., piezoelectric elements 10, 20 and 30 in first group G1, and piezoelectric elements 40, 50 and 60 in second group G2). Groups G1 and G2 are components of parallel-connected circuit parts. Using group selector switches 310, 320, it is possible to define which of groups G1, G2 of piezoelectric elements 10, 20 and 30, or 40, 50 and 60, respectively, are discharged via a common charging and discharging device (for charging processes, however, group selector switches 310, 320 have no significance, as will be described in detail below). Piezoelectric elements 10, 20 and 30 of first group G1 are located on one actuator bank, and piezoelectric elements 40, 50 and 60 of second group G2 are located on another actuator bank. A unit in which two or more actuator elements, in particular piezoelectric elements, are permanently installed—sealed-in, for example—is designated here as an actuator bank.

Group selector switches 310, 320 are located between a coil 240 and the particular groups G1 and G2 (their terminals on the coil side) and are implemented in the form of transistors. Drivers 311, 312 are implemented, which convert control signals received from trigger IC E into voltages that are selectable, if necessary, for closing and opening the switches.

Diodes 315 and 325 (designated as group selector diodes) are provided in parallel to group selector switches 310, 320. If group selector switches 310, 320 are designed as MOSFETs or IGBTs, then these group selector diodes 315 and 325 may be formed by the parasitic diodes themselves, for example. During charging processes, group selector switches 310, 320 are shunted by diodes 315, 325. The functionality of group selector switches 310, 320 is therefore reduced to selection of a group G1, G2 of piezoelectric elements 10, 20 and 30, or 40, 50 and 60, solely for the discharging process.

Within groups G1 and G2, piezoelectric elements 10, 20 and 30, or 40, 50 and 60, are provided as components of parallel-connected piezoelectric branches 110, 120 and 130 (group G1), and 140, 150 and 160 (group G2), respectively. Each piezoelectric branch includes a series connection having a first parallel connection that includes a piezoelectric element 10, 20, 30, 40, 50 or 60, and a resistor 13, 23, 33, 43, 53 or 63 (designated as branch resistor), and a second parallel connection that includes a selector switch in the form of a transistor 11, 21, 31, 41, 51, or 61 (designated as branch selector switch) and a diode 12, 22, 32, 42, 52, or 62 (designated as branch diode).

Branch resistors 13, 23, 33, 43, 53 or 63 cause the particular corresponding piezoelectric element 10, 20, 30, 40, 50 or 60 to discharge continuously during and after a charging process since in each case they connect both terminals of capacitive piezoelectric elements 10, 20, 30, 40, 50 or 60 with one another. Branch resistors 13, 23, 33, 43, 53 or 63, however, are of a sufficient size that they are able to slow down this process, compared with the controlled charging and discharging processes, as described below. For this reason, the charging of any one piezoelectric element 10, 20, 30, 40, 50 or 60 within a relevant time after a charging process shall be considered constant.

The branch selector switches or branch diode pairs in individual piezoelectric branches 110, 120, 130, 140, 150 or 160, i.e., selector switch 11 and diode 12 in piezoelectric branch 110, selector switch 21 and diode 22 in piezoelectric branch 120, etc., may be implemented in the form of electronic switches (i.e., transistors) having parasitic diodes—MOSFETs or IGBTs, for example (as specified above for group selector switch-diode pairs 310, 315 or 320, 325, respectively).

Using branch selector switches 11, 21, 31, 41, 51 or 61, it is possible to define which of piezoelectric elements 10, 20, 30, 40, 50 or 60 are charged in each case by a common charging and discharging device: all those piezoelectric elements 10, 20, 30, 40, 50 or 60, whose branch selector switches 11, 21, 31, 41, 51 or 61 are closed during the charging process described below are charged in each case. Normally, it is always only one of the branch selector switches that is closed.

Branch diodes 12, 22, 32, 42, 52 and 62 are used to shunt branch selector switches 11, 21, 31, 41, 51 or 61 during discharging processes. For this reason, each individual piezoelectric element may be selected for charging processes in the embodiment shown here, whereas for discharging processes either first group G1 of piezoelectric elements 10, 20 and 30, or second group G2 of piezoelectric elements 40, 50 and 60, and/or both groups must be selected.

Returning to piezoelectric elements 10, 20, 30, 40, 50 and 60, branch selector piezoelectric terminals 15, 25, 35, 45, 55 or 65 may be connected to ground either via branch selector switches 11, 21, 31, 41, 51 or 61, or via corresponding diodes 12, 22, 32, 42, 52 or 62, as well as, in both cases, via resistor 300.

The currents flowing between branch selector piezoelectric terminals 15, 25, 35, 45, 55 or 65 and ground are measured during charging and discharging of piezoelectric elements 10, 20, 30, 40, 50 and 60 by way of resistor 300. Knowledge of these currents makes controlled charging and discharging of piezoelectric elements 10, 20, 30, 40, 50 and 60 possible. In particular, by closing and opening charging switch 220 or discharging switch 230 as a function of the absolute value of current, it is possible to adjust the charging current or discharging current to specified mean values and/or prevent them from exceeding or falling below specified maximum values and/or minimum values.

In the embodiment shown in FIG. 1, the measurement itself requires another voltage source 621, which supplies a voltage of 5 V DC, for example, as well as a voltage divider in the form of two resistors 622 and 623. This is intended to protect trigger IC E (which performs the measurements) from negative voltages that might otherwise occur at measuring point 620 and that are not controllable using trigger IC E: this type of negative voltages are compensated by addition of a positive voltage supplied by the system including the voltage source 621 and voltage divider resistors 622 and 623.

The other terminal of the particular piezoelectric element 10, 20, 30, 40, 50 and 60, i.e., the particular group selector piezoelectric terminal 14, 24, 34, 44, 54, or 64, may be connected to the plus pole of a voltage source via group selector switch 310 or 320, or via group selector diode 315 or 325, as well as via a coil 240 and a parallel connection that includes a charging switch 220 and a charging diode 221, and, alternatively or additionally, may be grounded via group selector switch 310 or 320, or via diode 315 or 325, as well as via coil 240 and a parallel connection that includes a discharging switch 230 and a discharging diode 231. Charging switch 220 and discharging switch 230, for example, are implemented in the form of transistors that are triggered via drivers 222 or 232, respectively.

The voltage source includes a capacitor 210. Capacitor 210 is charged by a battery 200 (a motor vehicle battery, for example) and a downstream DC converter 201. DC converter 201 converts the battery voltage (12 V, for example) into basically any other DC voltage (250 V, for example), and charges up capacitor 210 to this voltage. DC converter 201 is controlled via transistor switch 202 and resistor 203, which is used for measuring the currents picked up at measuring point 630.

For countercheck purposes, another current measurement at measuring point 650 is made possible by trigger IC E and by resistors 651, 652 and 653, and, for example, a 5 V DC voltage source 654; in addition, a voltage measurement at measuring point 640 is possible via trigger IC E and by voltage-dividing resistors 641 and 642.

Finally, a resistor 330 (designated as a total discharge resistor), a switch 331 (designated as a stop switch) and a diode 332 (designated as a total discharge diode) are used to discharge piezoelectric elements 10, 20, 30, 40, 50 and 60 (in the event they are discharged outside the normal operation, as described below, and not through the “normal” discharging process). Stop switch 331 is closed after “normal” discharging processes (cyclical discharging via discharge switch 230), and thereby connects piezoelectric elements 10, 20, 30, 40, 50 and 60 to ground via resistors 330 and 300. In this way, any remaining residual voltages in piezoelectric elements 10, 20, 30, 40, 50 and 60 are eliminated. Total discharge diode 332 prevents negative voltages from occurring in piezoelectric elements 10, 20, 30, 40, 50 and 60, which might be damaged by the negative voltages under certain conditions.

The charging and discharging of all piezoelectric elements 10, 20, 30, 40, 50 and 60, or of a specific piezoelectric element 10, 20, 30, 40, 50 or 60, is effected using a single charging and discharging device (common to all groups and their piezoelectric elements). In the embodiment shown in FIG. 1, the common charging and discharging device includes battery 200, DC converter 201, capacitor 210, charging switch 220 and discharging switch 230, charging diode 221 and discharging diode 231, and coil 240.

Each piezoelectric element is charged and discharged in the same way as is explained below with reference to only the first piezoelectric element, i.e., piezoelectric element 10.

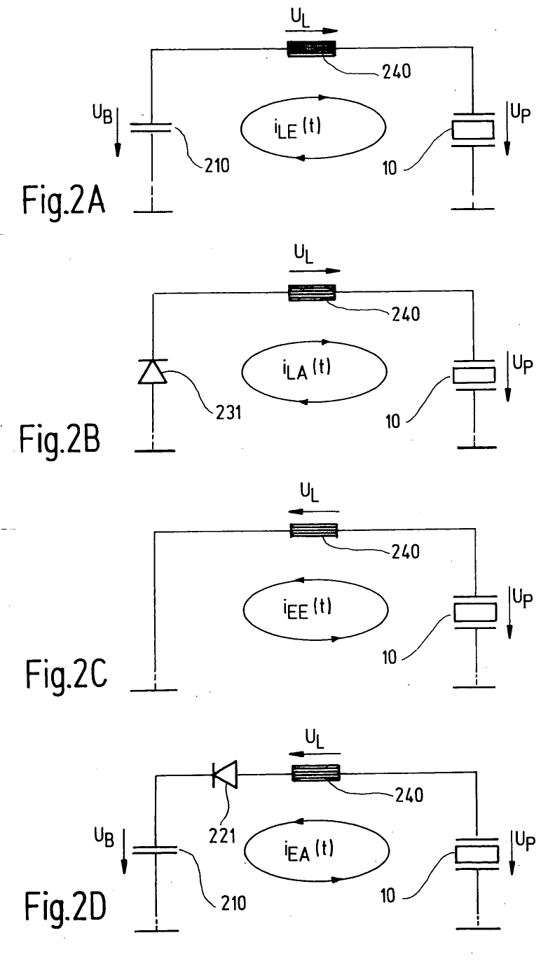

The states that occur during the charging and discharging processes are explained with reference to FIGS. 2A through 2D; of these figures, FIGS. 2A and 2B illustrate the charging of piezoelectric element 10, and FIGS. 2C and 2D illustrate the discharging of piezoelectric element 10.

The selection of one or more piezoelectric elements 10, 20, 30, 40, 50 and 60 to be charged or discharged, the charging process described below and the discharging process are controlled by trigger IC E and control unit D by opening or closing one or more of the switches introduced above, switches 11, 21, 31, 41, 51, and 61; 310, and 320; 220, and 230; and 331. The interactions between the elements within area A, the area shown in detail, and between trigger IC E and control computer D will be explained in greater detail below.

As regards the charging process, a piezoelectric element 10, 20, 30, 40, 50 or 60 to be charged must first be selected. In order to charge only first piezoelectric element 10, branch selector switch 11 of first branch 110 is closed, while all other branch selector switches 21, 31, 41, 51, and 61 remain open. To charge any one of the other piezoelectric elements 20, 30, 40, 50, or 60 exclusively or to charge several at the same time, that element or those elements would be selected by closing corresponding branch selector switches 21, 31, 41, 51, and/or 61.

The actual charging process may then take place, as explained below:

Within the example embodiment shown, a positive potential difference between capacitor 210 and group selector piezoelectric terminal 14 of first piezoelectric element 10 is used for the charging process. As long as charging switch 220 and discharging switch 230 are open, however, no charging or discharging of piezoelectric element 10 occurs. In this state, the circuit shown in FIG. 1 is in a steady state, i.e., piezoelectric element 10 retains its charge state essentially unchanged, and no currents flow.

To charge the first piezoelectric element 10, switch 220 is closed. Theoretically, it might be possible for first piezoelectric element 10 to be charged by this event alone. However, this would result in excessively large currents that might damage the elements in question. For this reason, the currents that occur are measured at measuring point 620, and switch 220 is opened again as soon as the measured currents exceed a specific limiting value. In order to attain any charge in first piezoelectric element 10, charging switch 220 is therefore closed and opened repeatedly while discharging switch 230 remains open.

When viewed in greater detail, the conditions shown in FIG. 2A result when charging switch 220 is closed, i.e., a closed circuit that includes a series connection having piezoelectric element 10, capacitor 210 and coil 240 is formed, and a current i_{LE}(t) flows in the circuit, as indicated by arrows in FIG. 2A. Because of this current flow, positive charges are supplied to group selector piezoelectric terminal 14 of first piezoelectric element 10, and energy is stored in coil 240.

If charging switch 220 opens briefly (several μs, for example) after closing, the conditions shown in FIG. 2B result: a closed circuit that includes a series connection having piezoelectric element 10, discharging diode 231, and coil 240 is formed, and a current i_{LA}(t) flows in the circuit, as indicated by arrows in FIG. 2B. Because of this current flow, energy stored in coil 240 flows into piezoelectric element 10. In accordance with the energy supply to piezoelectric element 10, both the voltage occurring in the element and the element's external dimensions increase. Once energy has been transferred from coil 240 to piezoelectric element 10, the circuit's steady state, which is shown in FIG. 1 and was already described, is again reached.

At this point in time, or earlier or later (depending on the desired time profile of the charging process), charging switch 220 is again closed and opened so that the processes described above take place again. Because charging switch 220 has closed again and opened again, the energy stored in piezoelectric element 10 increases (the energy already stored in piezoelectric element 10 and the newly supplied energy are added together), and the voltage occurring in piezoelectric element 10 increases, and the element's external dimensions increase accordingly.

If the closing and opening of charging switch 220 as described above is repeated many times, then the increase in the voltage occurring in piezoelectric element 10 and the expansion of piezoelectric element 10 occurs gradually.

If charging switch 220 has been closed and opened a specified number of times, and/or piezoelectric element 10 has reached the desired charge state, then charging of the piezoelectric element is terminated by leaving charging switch 220 open.

With regard to the discharging process, piezoelectric elements 10, 20, 30, 40, 50 and 60 in the example embodiment shown are discharged in groups (G1 and/or G2), as described in the following:

First, group selector switch 310 and/or 320 of group G1 and/or G2, whose piezoelectric elements are to be discharged, are closed (branch selector switches 11, 21, 31, 41, 51, 61 have no effect on selection of piezoelectric elements 10, 20, 30, 40, 50, 60 for the discharging process, since in this case they are shunted by diodes 12, 22, 32, 42, 52, and 62). In order to discharge piezoelectric element 10 as a part of first group G1, first group selector switch 310 is therefore closed.

If discharging switch 230 is closed, the conditions shown in FIG. 2C result: a closed circuit that includes a series connection having piezoelectric element 10 and coil 240 is formed, and current i_{EE}(t) flows in the circuit, as indicated by arrows in FIG. 2C. Because of this current flow, the energy stored in the piezoelectric element (a part thereof) is transferred to coil 240. In accordance with the energy transmission from piezoelectric element 10 to coil 240, the voltage occurring in piezoelectric element 10 drops and the element's external dimensions are reduced.

If discharging switch 230 opens briefly (several μs, for example) after closing, the conditions shown in FIG. 2D result: a closed circuit that includes a series connection having piezoelectric element 10, capacitor 210, charging diode 221 and coil 240 is formed, and current i_{EA}(t) flows in the circuit, as indicated by arrows in FIG. 2D. Because of this current flow, energy stored in coil 240 is returned to capacitor 210. Once energy transfer from coil 240 to capacitor 210 has been completed, the circuit's steady state, which is shown in FIG. 1 and was already described, is again reached.

At this point in time, or earlier or later (depending on the desired time profile of the discharging process), discharging switch 230 is again closed and opened so that the processes described above take place again. Because discharging switch 230 has again closed and opened again, the energy stored in piezoelectric element 10 decreases further, and both the voltage occurring in the piezoelectric element and the element's external dimensions likewise decrease accordingly.

If the closing and opening of discharging switch 230, as mentioned above, are repeated many times, then the decrease in the voltage occurring in piezoelectric element 10 and in the expansion of piezoelectric element 10 occurs gradually.

If discharging switch 230 has been closed and opened a specified number of times, and/or the piezoelectric element has reached the desired charge state, then discharging of the piezoelectric element is terminated by leaving discharging switch 230 open.

Trigger CI E and control computer D interact with the elements within area A, the area shown in detail, through control signals that are fed from trigger IC E to elements within area A, the area shown in detail, via branch selector control lines 410, 420, 430, 440, 450, 460, group selector control lines 510, 520, stop switch control line 530, charging switch control line 540, discharging switch control line 550, and control line 560. In addition, sensor signals are measured at measuring points 600, 610, 620, 630, 640, 650 within area A, the area shown in detail, and these signals are supplied to trigger IC E via sensor lines 700, 710, 720, 730, 740 and 750.

For selection of piezoelectric elements 10, 20, 30, 40, 50 or 60 for the execution of charging or discharging processes for individual or several piezoelectric elements 10, 20, 30, 40, 50, 60 by opening and closing the corresponding switches as described above, voltages are applied or not applied to the transistor bases via the control lines. In particular, the resulting voltage of piezoelectric elements 10, 20 and 30, or 40, 50 and 60 at measuring points 600 or 610, respectively, and the charging and discharging currents at measuring point 620, are determined by way of the sensor signals.

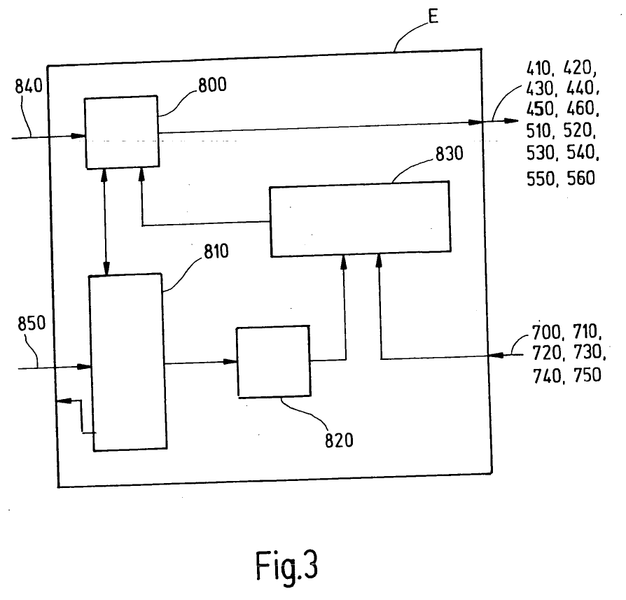

Some of the structural components contained in trigger IC E are specified in FIG. 3: a logic circuit 800, memory 810, digital-analog converter module 820 and comparator module 830. It is also specified that the fast parallel bus 840 (used for control signals) is connected to logic circuit 800 of trigger IC E, while the slower serial bus 850 is connected to memory 810. Logic circuit 800 is connected to memory 810, to comparator module 830 and to signal lines 410, 420, 430, 440, 450 and 460; 510 and 520; 530, 540, 550 and 560. Memory 810 is connected to logic circuit 800 and to digital-analog converter module 820. Furthermore, digital-analog converter module 820 is connected to comparator module 830. In addition, comparator module 830 is connected to sensor lines 700 and 710, 720, 730, 740 and 750, and—as already mentioned—to logic circuit 800.

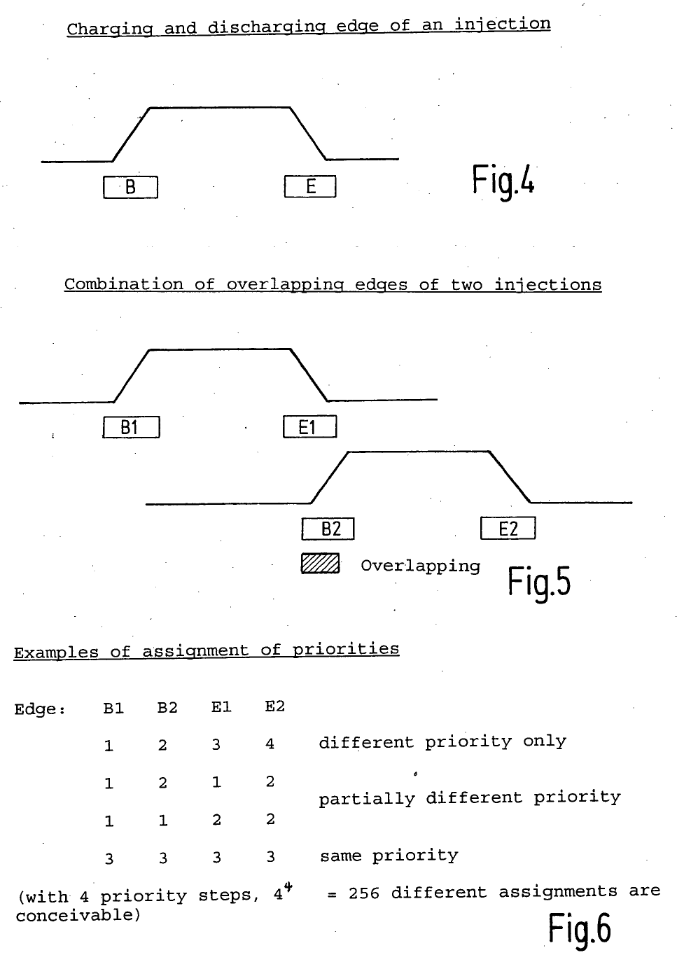

The injection of the piezoelectric elements is characterized by a charging and a discharging edge, as shown in FIG. 4, for example. In the following, the charging edge will be referred to as starting edge B, and the discharging edge as end edge E. As mentioned above, one design-related restriction for piezoelectric elements is that only one charging or discharging edge may occur at the same time. In the case of detected overlapping, therefore, a response must occur based on a defined strategy. First, any combination of overlapping edges of two injections is assumed, as is shown schematically in FIG. 5.

The possible strategies are any desired combinations of the following measures:

1. Any priorities are assigned to the four edges, as shown in FIG. 6. All four edges may have

a) different priorities only, or

b) partially different priorities, or

c) the same priority.

2. One measure for singular primary collisions is described as follows. A singular primary collision is defined as an overlapping of any two edges having the same or different priority, provided that no other edge pair overlaps at the same time. In this case, the following shifts are possible:

a) advancing the low-priority edge, or

b) retarding the low-priority edge, or

c) advancing the higher-priority edge, or

d) retarding the higher-priority edge, or

e) advancing the higher-priority edge, simultaneously retarding the low-priority edge, or

f) retarding of the higher-priority edge, simultaneously advancing the higher-priority edge, or

g) retarding of the higher-priority edge, simultaneously retarding the low-priority edge, or

h) advancing of the higher-priority edge, simultaneously advancing the low-priority edge,

so that the time interval in which one piezoelectric element is to be charged or discharged does not overlap with the time interval in which the other piezoelectric element is to be charged or discharged.

If the priority of the two edges is the same, the higher-priority injection or the low-priority injection may be advanced or retarded in any way desired.

If the edge that is advanced is a starting edge, then the measure corresponds to an advance of the injection, provided that the associated end edge is advanced by the same amount.

If the edge that is advanced is an end edge, then the measure corresponds to a shortening of the injection duration, provided that the associated starting edge remains unchanged.

If the edge that is retarded is a starting edge, then the measure corresponds to a retardation of the injection, provided that the associated end edge is retarded by the same amount.

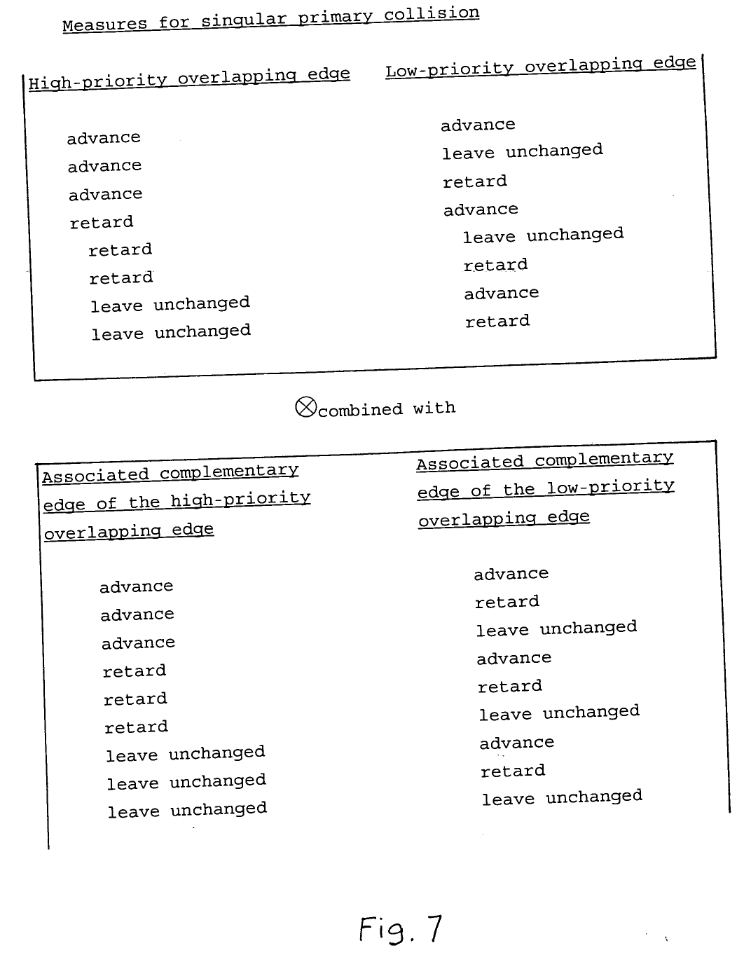

If the edge that is retarded is an end edge, then the measure corresponds to a lengthening of the injection duration, provided that the associated starting edge remains unchanged. In addition, it is also possible for the edges not involved in overlapping to be advanced or retarded. Different example combinations are shown in FIG. 7.

If both overlapping edges are advanced, the degree of shifting must be different; the same applies to retarding both overlapping edges.

3. Measures for Singular Secondary Collision:

A singular secondary collision is defined as an overlapping resulting from the shifting of the primary collision in which any two edges having the same or different priority overlap, provided that no other edge pair overlaps at the same time. In this case, the same measures for shifting as for a singular primary collision are possible. The measure for shifting in the case of a singular secondary collision should be selected so that no other subsequent collision occurs. Apart from this, a tertiary or higher-value collision is also possible, to which the response must be analogous to the primary and secondary collisions.

4. Measures For Multiple Primary Collision:

A multiple primary collision is defined as a combined overlapping of any three or four edges. In the case of an overlapping of four edges, the-latter may overlap either in combination or separately. Any shifting measures desired are possible as long as the following boundary conditions are met:
a) Each of the overlapping edges may be advanced or retarded.
b) Not all overlapping edges must be shifted.
c) After the shift, the previously overlapping edges are non-overlapping so that the time interval in which one piezoelectric element is to be charged or discharged does not overlap with the time interval in which the other piezoelectric element is to be charged or discharged.
d) In addition, edges not involved in the overlapping may be advanced or retarded.
   5. Measures For Multiple Secondary Collision:

A multiple secondary collision is defined as a combined overlapping of any three or four edges that results from the measure for shifting a primary collision. In this case, the same measures as for a multiple primary collision are possible. The measure for a multiple secondary collision should be logical so that no subsequent collision will occur. Apart from this, a tertiary or higher-value collision is also possible, to which the response must be analogous to the primary and secondary collisions.

6. Variants of these measures are possible, in which case the following must be considered in addition to the measures for shifting cited above in items 2 to 5:

a) In the selection of shifts, not only the priorities but also the types of colliding injections are considered;
b) in the selection of shifts, shifts in the past for the same type of overlapping as the one being analyzed and/or another type of overlapping are considered;
c) the injection assigned to the high-priority edge is not executed, if causally possible;
d) the injection assigned to the low-priority edge is not executed, if causally possible;
e) one or more injections are added so that the setpoint quantity is reached in the event of shortening, for example;
f) if an injection is advanced or retarded, and/or shortened or lengthened, then one or more other injection(s) not affected by the overlapping is (are) changed in the same or in a different way, and thus—in the case, for example, of a changed first post-injection—the second post-injection that is then not affected may be changed. Under certain conditions, the injection may also not be executed at all. Moreover, it is conceivable that edges of more than two injections overlap or that as the result of a measure a collision with another injection follows. In this case, the shifting measures described above in items 4 a) through 4 d) are also possible.

1-15. (canceled)

16. A fuel injection system for an internal combustion engine having at least two cylinders, comprising:
at least two actuator elements, wherein at least one actuator element is assigned to each cylinder for injecting fuel into the cylinder; and
an injection regulating system for at least one of monitoring and resolving a conflict when triggering the actuator elements, wherein the injection-regulating system triggers at least one of the actuator elements at least one of earlier, later, and not at all, as a function of at least one of charging and discharging edges of the actuator elements during injections.

17. The fuel injection system as recited in claim 16, wherein the actuator elements are piezoelectric elements.

18. The fuel injection system as recited in claim 16, wherein the actuator elements are solenoid valves.

19. A fuel injection system for an internal combustion engine having at least two cylinders, comprising:
at least two piezoelectric elements, wherein at least one piezoelectric element is assigned to each cylinder for injecting fuel into the cylinder by at least one of charging and discharging of the piezoelectric element, wherein a single supply unit at least one of charges and discharges the piezoelectric elements; and
an injection-regulating system for monitoring an overlap of a time interval in which a first piezoelectric element is to be at least one of charged and discharged with a time interval in which a second piezoelectric element is to be at least one of charged and discharged, wherein different priorities are assigned to at least two injections in such a way that a first injection is assigned a higher priority than a second injection, and
wherein the injection-regulating system at least one of advances, retards, and cancels at least one of the first and second injections as a function of at least one of charging and discharging edges of the piezoelectric elements during injections, so that one piezoelectric element is not charged if the other piezoelectric element is to be one of charged and discharged.

20. A method for operating a fuel injection system for an internal combustion engine having at least two cylinders, the fuel injection system having at least two actuator elements, wherein at least one actuator element is assigned to each cylinder for injecting fuel into the cylinder, the method comprising:
monitoring for a conflict between triggering of the two actuator elements;
resolving the conflict by an injection-regulating system, wherein the injection-regulating system triggers at least one of the actuator elements at least one of earlier, later, and not at all, as a function of at least one of charging and discharging edges of the actuator elements during injections.

21. A method for operating a fuel injection system for an internal combustion engine having at least two cylinders, the fuel injection system having at least two piezoelectric elements, wherein at least one piezoelectric element is assigned to each cylinder for injecting fuel into the cylinder by at least one of charging and discharging of the piezoelectric element, and wherein a single supply unit at least one of charges and discharges the piezoelectric elements, the method comprising:
monitoring, by using an injection-regulating system, for an overlap of a first time interval in which a first piezoelectric element is to be at least one of charged and discharged with a second time interval in which a second piezoelectric element is to be at least one of charged and discharged; and
at least one of advancing, retarding, and canceling at least one of first and second injections, by using the injection-regulating system, as a function of at least one of charging and discharging edges of the piezoelectric elements during injections, so that one piezoelectric element is not charged if the other piezoelectric element is to be one of charged and discharged.

22. The method as recited in claim 21, wherein different priorities are assigned to the first and second injections, and wherein the at least one of advancing, retarding, and canceling at least one of the first and second injections is determined as a function of relative priorities of the injections.

23. The method as recited in claim 21, wherein different priorities are assigned to the first and second injections, and wherein the at least one of advancing, retarding, and canceling at least one of the first and second injections is determined independently of relative priorities of the injections.

24. The method as recited in claim 21, wherein the at least one of advancing, retarding, and canceling at least one of the first and second injections is determined as a function of a type of overlap between the first time interval and the second time interval.

25. The method as recited in claim 21, wherein the at least one of advancing, retarding, and canceling at least one of the first and second injections is determined independently of a type of overlap between the first time interval and the second time interval.

26. The method as recited in claim 21, wherein the at least one of advancing, retarding, and canceling at least one of the first and second injections is determined as a function of a type of injection for at least one of the first and second injections, and wherein different types of injection include a pilot injection, a main injection, an a post-injection).

27. The method as recited in one of claim 21, wherein the at least one of advancing, retarding, and canceling at least one of the first and second injections is determined as a function of a previous injection-timing adjustment.

28. The method as recited in claim 20, wherein for singular primary collision and secondary collision, the at least one of advancing, retarding, and canceling at least one of the first and second injections includes one of:
a) advancing a low-priority injection edge;
b) retarding a low-priority injection edge;
c) advancing a higher-priority injection edge;
d) retarding a higher-priority injection edge;
e) advancing a higher-priority injection edge and simultaneously retarding a low-priority injection edge;
f) retarding a higher-priority injection edge and simultaneously advancing a low-priority injection edge;
g) retarding a higher-priority injection edge and simultaneously retarding a low-priority injection edge; and
h) advancing a higher-priority injection edge and simultaneously advancing a low-priority injection edge.

29. The method as recited in claim 28, wherein injection edges not involved in the overlap are left unchanged.

30. The method as recited in claim 28, wherein for a multiple primary collision and a secondary collision, the at least one of advancing, retarding, and canceling at least one of the first and second injections is achieved by satisfying the following boundary conditions:
a) each of overlapping injection edges is allowed to be at least one of advanced and retarded;
b) not all overlapping injection edges must be shifted;
c) after the at least one of advancing, retarding, and canceling at least one of the first and second injections, the previously overlapping injection edges are non-overlapping, so that a time interval in which the first piezoelectric element is to be at least one of charged and discharged does not overlap with a time interval in which the second piezoelectric element is to be at least one of charged and discharged; and
d) injection edges not involved in the overlap are allowed to be at least one of advanced and retarded.

31. The method as recited in claim 21, wherein for singular primary collision and secondary collision, the at least one of advancing, retarding, and canceling at least one of the first and second injections includes one of:
a) advancing a low-priority injection edge;
b) retarding a low-priority injection edge;
c) advancing a higher-priority injection edge;
d) retarding a higher-priority injection edge;
e) advancing a higher-priority injection edge and simultaneously retarding a low-priority injection edge;
f) retarding a higher-priority injection edge and simultaneously advancing a low-priority injection edge;
g) retarding a higher-priority injection edge and simultaneously retarding a low-priority injection edge; and
h) advancing a higher-priority injection edge and simultaneously advancing a low-priority injection edge.

32. The method as recited in claim 31, wherein injection edges not involved in the overlap are left unchanged.

33. The method as recited in claim 31, wherein for a multiple primary collision and a secondary collision, the at least one of advancing, retarding, and canceling at least one of the first and second injections is achieved by satisfying the following boundary conditions:
a) each of overlapping injection edges is allowed to be at least one of advanced and retarded;
b) not all overlapping injection edges must be shifted;
c) after the at least one of advancing, retarding, and canceling at least one of the first and second injections, the previously overlapping injection edges are non-overlapping, so that a time interval in which the first piezoelectric element is to be at least one of charged and discharged does not overlap with a time interval in which the second piezoelectric element is to be at least one of charged and discharged; and
d) injection edges not involved in the overlap are allowed to be at least one of advanced and retarded.
